(19) United States
(12) Patent Application Publication
(10) Pub. No.: US 2005/0248289 A1
(43) Pub. Date: Nov. 10, 2005

(54) Driver for a gas discharge lamp

(75) Inventors: Dolf Henricus Jozef Van Casteren, Eindhoven (NL); Winston Donald Couwenberg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/522,290

(22) PCT Filed: Jul. 10, 2003
(86) PCT No.: PCT/IB03/03145

§ 371 Date: Jan. 25, 2005

(30) Foreign Application Priority Data
Jul. 30, 2002 (EP) 02078133.2

(51) Int. Cl. H05B 37/02

(52) U.S. Cl. 315/224; 315/291; 315/307; 315/308

(57) ABSTRACT

A two-stage electronic ballast (301; 401) for driving a gas discharge lamp comprises:—a half-bridge commutating forward stage (250) comprising a series arrangement of a first buffer capacitor (251) and a second buffer capacitor (252) connected between two bridge input terminals (261, 262);—and a double flyback converter stage (310; 410) comprising an inductive energy storage buffer (320; 420) having at least one input circuit (330) suitable for receiving a rectified AC mains input voltage, the buffer further having at least two output circuits (340, 350), each output circuit being coupled to a respective buffer capacitor (251, 252) of said half-bridge commutating forward (HBCF) stage (250) for individually charging said buffer capacitors (251, 252).

The present invention relates in general to drivers for gas discharge lamps. More specifically, the present invention relates to a driver for a metal halide lamp.

As is commonly known, a driver for a gas discharge lamp serves to feed the gas discharge lamp with the required amount of current, and receives itself its power from rectified AC mains. A well known conventional driver has a three-stage design. A first stage comprises an up-converter which receives the rectified AC mains input voltage and converts this input voltage to a higher DC output voltage. A second stage comprises a down converter which receives the DC output voltage from the up converter, and provides at its output a lower DC voltage (lamp voltage) and a required lamp current. This down converter has a current source characteristic, i.e. it controls the lamp current to a substantially constant value. A third stage comprises a commutator which regularly changes the direction of the lamp current, at a frequency typically in the order of about 100 Hz. In other words, although the lamp is operated at substantially constant current magnitude, the lamp current regularly changes its direction within a very brief time (commutating period).

Such three-stage electronic ballast design functions well, but has the disadvantage of being rather complicated and relatively costly. An alternative design, having the advantage of having less components and therefore reduced costs, has a two-stage design wherein the function of lamp current control and commutation are combined into one stage. Thus, such a two-stage electronic ballast comprises a first stage up converter for receiving the rectified AC mains input voltage and providing a higher DC output voltage. As a second stage, this two-stage electronic ballast comprises a half-bridge forward commutating stage (HBCF). In general, such HBCF comprises three branches. A first branch comprises two switches connected in series between the input terminals receiving the DC voltage from the first stage. A second branch comprises two capacitors connected in series between said two input terminals. A third branch, comprising the lamp, is connected between on the one hand the node between said two switches and on the other hand the node between said two capacitors.

There are situations where the above-described two-stage design is disadvantageous with respect to the above-described three-stage design. These situations occur mainly when the gas discharge lamp shows an asymmetric current behavior. This asymmetric current behavior may be an undesired property of the lamp itself. The chances on asymmetric current behavior are particularly substantial when a lamp approaches the end of its operational life.

Under normal circumstances, the current flowing in one direction during one half of the current period has exactly the same magnitude as the current flying in the opposite direction during the second half of the lamp period, while further the first half of the lamp period has exactly the same duration as the second half of the lamp period. In such circumstances the voltage at said node between said two capacitors will be half the input voltage. However, in the asymmetric situations described above, the voltage at said node will shift to the voltage of one of the input terminals, due to the fact that one of said capacitors needs to provide more current than the other capacitor.

A similar problem occurs in circumstances where it is desired to drive the lamp at a duty cycle differing from 50%. Normally, the duty cycle of the lamp current is exactly 50%, this duty cycle being defined as the duration of the one half of the lamp period divided by the overall lamp period. Again, if the current magnitude in the one half lamp period is equal to the current magnitude in the other half lamp period whereas the duration of the one half lamp period differs from the duration of the other half lamp period, one of said capacitors needs to provide more current than the other, and the voltage level at said node between said two capacitors shifts to the voltage level of one of the input terminals.

The above-mentioned problems do not occur in the conventional three-stage design, where such capacitors are absent. Further, driving a lamp with a duty cycle differing from 50% is relatively easy in such conventional three-stage design, simply by selecting an appropriate timing for the switching of the commutator switches.

Accordingly, it is an objective of the present invention to provide an electronic ballast for a gas discharge lamp wherein the advantages of the two-stage converter are combined with the advantages of the three-stage converter.

More particularly, it is an objective of the present invention to provide an electronic ballast for a gas discharge lamp having a two-stage design so that it involves a relatively small amount of components and therefore Relatively low costs, the electronic ballast comprising a half bridge commutating forward stage as second stage, the electronic ballast being capable of handling asymmetric currents, wherein the problem of voltage shift at the node between said two capacitors is eliminated.

According to an important aspect of the present invention, the electronic ballast comprises a double fly back converter as first stage, each fly back converter being coupled to a respective one of said capacitors, this double fly back converter circuit acting as power factor correction circuit charging each capacitor substantially independently from the other capacitor, such that the voltage shift during operation is avoided or limited to a relatively small and acceptable extent.

These and other aspects, features and advantages of the present invention will be further explained by the following description of preferred embodiments of the driver according to the present invention with reference to the drawings, in which same reference numerals indicate same or similar parts, and in which:

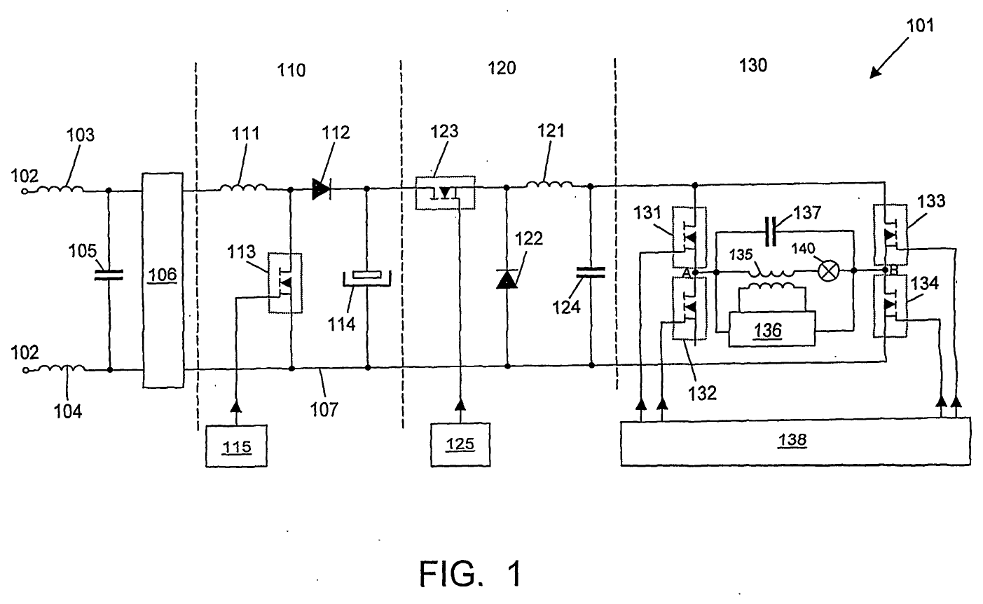

FIG. 1 schematically illustrates a conventional three-stage design of an electronic ballast;

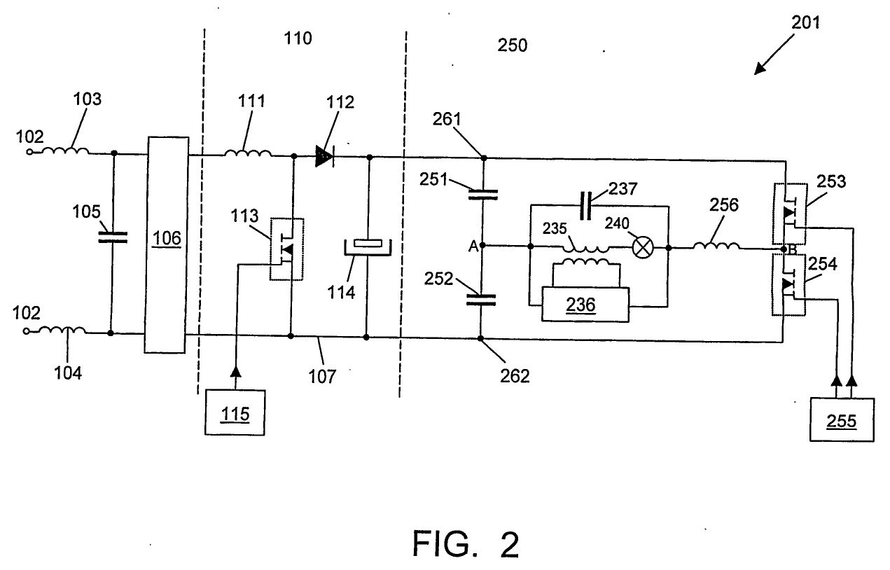

FIG. 2 schematically illustrates a conventional two-stage design of an electronic ballast;

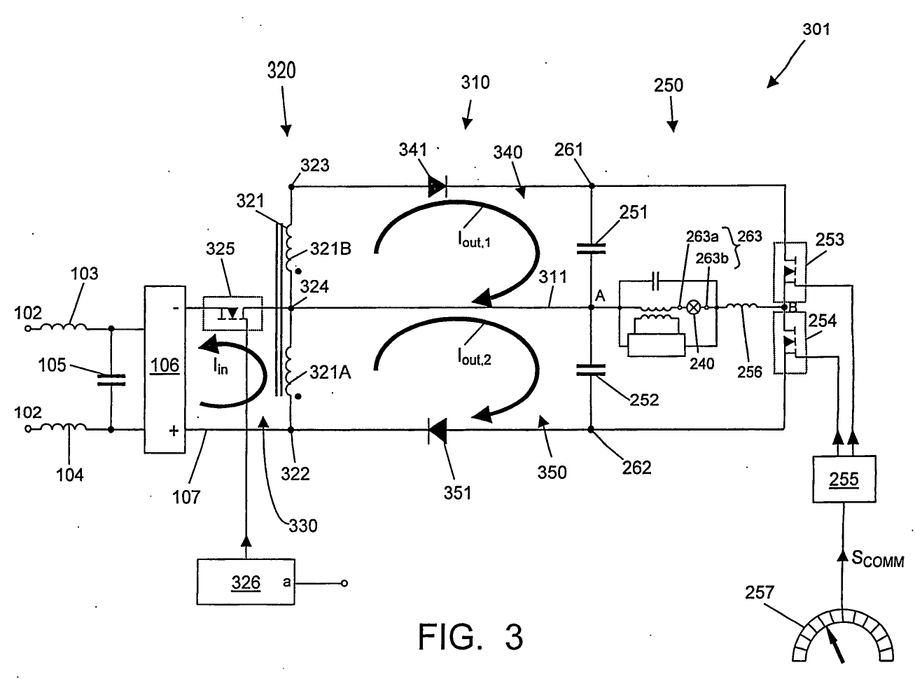

FIG. 3 schematically illustrates a first embodiment of a two-stage electronic ballast according to the present invention;

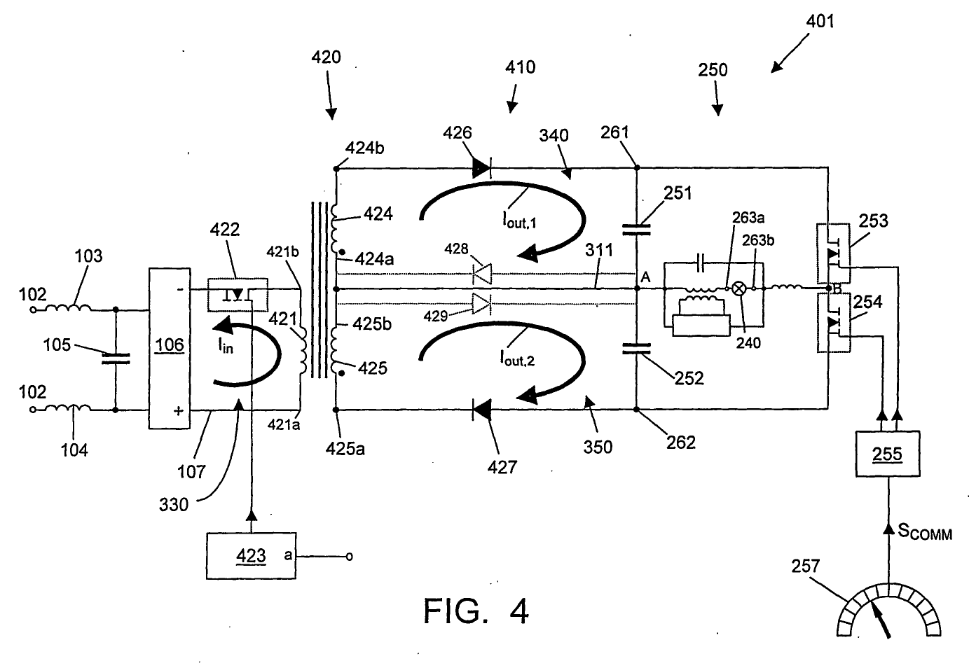

FIG. 4 schematically illustrates a second embodiment of a two-stage electronic ballast according to the present invention.

FIG. 1 schematically illustrates a typical electronic ballast 101 according to the conventional three-stage design.

The electronic ballast 101 comprises a first stage up converter 110, a second stage down converter 120, and a third stage commutator 130. The input of the up converter stage 110 may be provided with a pre-conditioner and rectifier for filtering and rectifying the AC mains input voltage received at an input 102. Such pre-conditioner may comprise a first inductor 103 connected in series with one input terminal, a second inductor 104 connected to the other input terminal, and a capacitor 105 connected in parallel to output terminals of said inductors 103 and 104. The pre-conditioner may further comprise a rectifying unit 106, such as for instance a diode bridge. Thus, at its input, the up converter 110 receives rectified AC mains voltage.

The electronic ballast 101 has a common rail 107 connected to one input terminal of the up converter 110, this rail 107 being common to all three stages; the voltage level at this common rail 107 will be referred to as zero voltage. The up converter 110 comprises a series arrangement of an inductor 111 having one terminal coupled to one input terminal of the up converter 110, and a diode 112 having its anode connected to the inductor 111 and having his cathode coupled to the output of the up converter 110. A controllable switch (MOSFET) 113, controlled by a first control unit 115, is connected between the common rail 107 and the node between said inductor 111 and said diode 112. A buffer capacitor 114 is connected in parallel to the output of the up converter 110.

The up converter 110 provides at its output a DC voltage having a voltage level higher than the rectified AC mains voltage.

The down converter 120 comprises a series arrangement of an inductor 121 having one terminal connected to the output of the down converter 120, and a controllable switch 123, controlled by a second control unit 125, the controllable switch 123 being connected between said inductor 121 and said diode 112. The down converter 120 further comprises a diode 122 having its anode connected to the common rail 107 and having its cathode connected to the node between said inductor 121 and said controllable switch 123. A filter capacitor 124 is connected in parallel to the output of the down converter 120.

The down converter 120 substantially acts as a current source, providing at its output a substantially constant current at a reduced voltage level.

The commutator stage 130 comprises a first series arrangement of two controllable switches (MOSFET) 131 and 132, connected between the input of the commutator and the common rail 107, and a second series arrangement of two controllable switches 133 and 134, also connected between said input and said common rail 107. The commutator 130 further comprises a series arrangement of the gas discharge lamp 140 and an igniter coil 135, associated with an igniter circuit 136, said series arrangement of igniter coil 135 and lamp 140 being connected between, on the one hand, a node A between said switches 131 and 132 and, on the other hand, a node B between said switches 133 and 134. A filter capacitor 137 is connected in parallel to said series arrangement of igniter coil 135 and lamp 140.

The controllable switches 131, 132, 133, 134 are controlled by a third control unit 138. The three control units 115, 125 and 138 may be combined into one combined control unit.

The first control unit 115 of the up converter 110 controls the controllable switch 113 such that the output voltage of the up converter is substantially constant. To that end, the output voltage of the up converter 110, at the cathode of the diode 112, is measured and a measuring signal is provided to said control unit 115, but for sake of simplicity this is not shown in FIG. 1. Controlling the output voltage of the up converter 110 is done by controlling the duty cycle of the controllable switch 113.

The second control unit 125 of the down converter 120 controls the controllable switch 123 such that the output power level of the down converter 120 is substantially constant. To that end, a measuring signal representing the input current of the down converter 120 is provided to the control unit 125, but for sake of simplicity this is not shown in FIG. 1. Controlling the output power is done by controlling the duty cycle of the controllable switch 123.

The third control unit 138 of the commutator stage 130 controls the four controllable switches 131 to 134 such that the output current of the down converter 120 is applied to the lamp 140 in alternating directions. In one half lamp period, the switches 131 and 134 are closed (conductive) while the switches 132 and 133 are open (non-conductive), so that the output current from down converter 120 is applied to the lamp 140 in the direction from node A to node B. In the other half lamp period, the switches 131 and 134 are open (non-conductive) while the switches 132 and 133 are closed (conductive), so that the output current from the down converter 120 is applied to the lamp 140 in the opposite direction.

Conventionally, the third control unit 138 of the commutator stage 130 controls the four switches 131-134 with a duty cycle of 50%, so that the duration of the one half lamp period is exactly the same as the duration of the other half lamp period However, if it is desired to operate the lamp 140 with a duty cycle differing from 50%, this can easily be achieved by adequate control of the four switches 131 to 134, as will be clear to a person skilled in the art.

FIG. 2 schematically illustrates a prior art electronic ballast 201 of the two stage type, comprising a first stage up converter 110 and a second stage half bridge commutating forward stage 250. The first stage up converter 110 may be identical to the up converter discussed above, as illustrated. Further, filter components 103, 104, 105 and rectifier 106 coupled to the input of the first stage up converter 110 may also be identical to the components discussed above. Thus, the second stage HBCF 250 receives at its input the boosted DC output voltage of the up converter 110.

The second stage HBCF 250 comprises a series arrangement of two buffer capacitors, typically electrolytic capacitors, 251 and 252, connected between input (node 261) and common rail 107 (node 262). A node between these two capacitors 251 and 252 is indicated at A. The second stage HBCF 250 further comprises a series arrangement of two controllable switches 253 and 254, also connected between said input and said common rail 107. A node between said two switches is indicated at B. Said controllable switches are controlled by a control unit 255.

Between said two nodes A and B, a lamp branch is connected. This lamp branch comprises a series arrangement of a lamp 240, an igniter coil 235 associated with an igniter circuit 236, and a current limiting coil 256. A filter capacitor 237 is connected in parallel to the series arrangement of said igniter coil 235 and said lamp 240.

From a comparison between the circuit of the two stage electronic ballast 201 illustrated in FIG. 2 and the three stage electronic ballast 101 illustrated in FIG. 1 it clearly follows that the two stage design illustrated in FIG. 2 is less complicated, and therefore less costly, than the three stage design illustrated in FIG. 1. As a further simplification, the buffer capacitor 114 of the up converter 110 may be omitted, its task being performed by the series arrangement of buffer capacitors 251 and 252 of HBCF 250.

In operation, the control unit 255 controls the controllable switches 253 and 254 as follows. During a first half lamp period, the first switch 253 is open (non-conductive) while the second switch 254 is repeatedly opened and closed at a relatively high frequency. This causes a lamp current to flow from node A to node B, wherein the current limiting coil 256 in conjunction with the high frequency switching of second switch 254 effects a limitation of the lamp current. In the second half lamp period, the situation is reversed, in that the second switch 254 is open (non-conductive) and the first switch 253 is switched open and closed at a high frequency, causing a lamp current to flow in the direction from node B to node A.

In this process, the buffer capacitors 251 and 252 are charged. If the lamp 240 is operated with symmetric current, i.e. if the two half lamp periods have equal duration and equal current magnitude, and if the lamp 240 shows symmetric behavior, the voltage level at node A between said two capacitors 251 and 252 will, on average, take a value of half the input voltage (i.e. half the output voltage of the up converter 110).

However, if the lamp 240 behaves in an asymmetric way, or if the control unit 255 controls the switches 253 and 254 in an asymmetric way (duty cycle differing from [symbol] acitor will always be consistently charged more than the other capacitor, so that the voltage level at node A will either rise to input voltage level or will drop to common rail voltage level.

FIG. 3 schematically shows an embodiment of an electronic ballast 301 according to the present invention, which has a relatively low complexity, comparable to the favorable complexity of the two stage design illustrated in FIG. 2, but which is capable of handling asymmetric lamp current without the above-mentioned disadvantages. The two stage electronic ballast 301 provided by the present invention comprises a first stage voltage converter 310 and a second stage HBCF 250, which may be identical to a prior art HBCF 250 as discussed above with reference to FIG. 2. For receiving, filtering and rectifying an AC mains voltage, the electronic ballast 301 may be provided with filter components 103, 104, 105 and rectifier 106, as discussed above.

A lamp 240 is connected between output terminals 263a, 263b of a lamp output 263, the first lamp output terminal 263a being coupled to the igniter coil 235, the second lamp output terminal 263b being coupled to the current limiting coil 256.

The first stage DC/DC converter 310 is, according to the basic principle of the present invention, implemented according to a double fly-back design, comprising an inductive energy storage buffer 320, at least one input circuit 330, and two output circuits 340 and 350, associated respectively to the first and second buffer capacitors 251 and 252 of the second stage HBCF 250. In the exemplary embodiment 301 illustrated in FIG. 3, the inductive energy storage buffer 320 comprises an electromagnetic coil 321 with a first end terminal 322, a second end terminal 323, and a central terminal 324. The coil portion between first input terminal 322 and central terminal 324 will be indicated as first coil section 321A, whereas the coil portion between central terminal 324 and second end terminal 323 will be indicated as second coil section 321B.

The first end terminal 322 is connected to the positive output terminal of rectifier 106, and the central terminal 324 is connected to the negative output terminal of rectifier 106. Thus, an input circuit 330 is defined, which includes the first coil section 321A. In this input circuit 330, a controllable switch, preferably a MOSFET, 325 is included. In the example shown, this controllable switch 325 is arranged between the negative rectifier output and the central coil terminal 324. The controllable switch 325 is controlled by a control unit 326.

A first output circuit 340 is defined by the second coil section 321B being connected in parallel to the first buffer capacitor 251. More particularly, a first diode 341 has [symbol] nnected to second coil end terminal 323 and has its cathode connected to an end terminal of first buffer capacitor 251 opposite node A, i.e. a first bridge input terminal 261. A second output circuit 350 is defined by the first coil section 321A being connected in parallel to the second buffer capacitor 252 of the HBCF 250. More particularly, a second diode 351 has its cathode connected to first end terminal 322 and has its anode connected to an end terminal of second buffer capacitor 252 opposite node A, i.e. a second bridge input terminal 262. The central coil terminal 324 is connected to node A by a common conductor 311, common to the first output circuit 340 and the second output circuit 350.

The operation of this double fly-back converter 310 is as follows. The control unit 326 controls the controllable switch 325 to switch repeatedly from its open (non-conductive) condition to its closed (conductive) condition. If the controllable switch 325 is closed, an input current flows through the first coil section 321A from its first end terminal 322 to its central terminal 324, as illustrated by arrow Iᵢₙ in FIG. 3. This input current charges the inductive energy storage buffer 320 with electromagnetic energy. When the controllable switch 325 is opened, this current can no longer flow in input circuit 330, so the inductive energy storage buffer 320 starts to discharge by generating output currents. This output currents have, within the coil 321, the same direction as the charging input current Iᵢₙ. More particularly, a first output current is generated by second coil section 321B, flowing from central terminal 324 to second end terminal 323, through first diode 341 and first buffer capacitor 251 to node A, and through common conductor 311 back to central terminal 324. This first output current is indicated by arrow In_{out,1} in FIG. 3. Similarly, a second output current I_{out,2} is generated by first coil section 321A, flowing from first end terminal 322 to central terminal 324, through common conductor 311 to node A, through second capacitor 252, and through second diode 351 back to first end terminal 322. Thus, the first and second buffer capacitors 251 and 252 are individually charged by the first output current I_{out,1} and the second output current I_{out,2}, respectively.

The operation of the second stage HBCF 250 is as usual. The control unit 255 controls the switches 253 and 254 such as to effect a commutating lamp current. If the lamp shows asymmetric behavior, or if the control unit 255 receives a command signal S_{comm}, for instance from a user-controllable input device 257, ordering it to drive the switches 253 and 254 with a duty cycle differing from 50%, one of the buffer capacitors 251, 252 may discharge more than the other one. The buffer capacitor which is discharged faster will show a smaller voltage drop than the other one, as a result of which the corresponding output current charging this capacitor will have a higher current magnitude. As a result, the capacitor which is discharged faster is also charged faster.

The control unit 326 comprises a voltage sensor input 326a coupled to receive a measuring signal representing the output voltage of the flyback converter stage 310, and generates a switch actuating signal such that the third controllable switch 325 is switched open and closed at a predetermined operating frequency. In this case, such measuring signal may represent the voltage over the series arrangement of capacitors 251 and 252, i.e. the voltage between terminals 261 and 262. The control unit 326 is responsive to such measuring signal to adapt the duty cycle of said switch actuating signal in order to maintain the output voltage at a predetermined level.

FIG. 4 schematically shows an embodiment 401 of the two stage electronic ballast according to the present invention, which is similar to the embodiment 301 illustrated in FIG. 3, but in which the inductive energy storage buffer 320 is replaced by a transformer-type storage buffer 420 having separate input windings and output windings on a common core. Thus, the inductive energy storage buffer 420 of this embodiment 401 has an input winding 421 having one end 421a connected to the positive output terminal of the rectifier 106, and its other terminal 421b coupled to the negative output terminal of this rectifier 106 through a controllable switch 422, which is controlled by a control unit 423, which has a voltage sensor input 423a, similarly as described above with reference to control unit 326. The inductive energy storage buffer 420 has a first output winding 424 having a first end terminal 424a and a second end terminal 424b, connected in parallel to the first buffer capacitor 251 of the HBCF 250, and a second output winding 425 having a first end terminal 425a and a second end terminal 425b, connected in parallel to the second buffer capacitor 252 of the HBCF 250. The first end terminal 424a of the first output winding 424 may be connected to the second output terminal 425b of the second output winding 425, in which case this node is connected to node A by a common conductor 311, similar as in the first embodiment 301 discussed above with reference to FIG. 3. In that case, a first diode 426 will be connected between the second end terminal 424b of the first output winding 424 and first buffer capacitor 251, and a second diode 427 will be connected between the first end terminal 425a of the second output winding 425 and the second buffer capacitor 252, similar to the diodes 341 and 351 discussed above. Alternatively, the first diode 426 may be replaced by a diode 428 connected between node A and the first end terminal 424a of first output winding 424 and the second diode 427 may be replaced by a diode 429 connected between node A and the second end terminal 425b of second output winding 425, as illustrated in dotted lines in FIG. 4. In this alternative case, the common conductor 311 is omitted, and the first end terminal 424a of first output winding 424 need not be connected to the second end terminal 425b of second output winding 425.

The operation of the second embodiment 401 is identical to the operation of the first embodiment 301. A typical feature of this second embodiment 401 is that it may provide a galvanic separation between input winding 421 and output windings 424 and 425, as illustrated. If such galvanic separation is not necessary or not desired, the first end terminal 421a of input winding 421 may be connected to the first end terminal 425a of second output winding 425.

It should be clear to a person skilled in the art that the present invention is not limited to the exemplary embodiments discussed above, but that various variations and modifications are possible within the protective scope of the invention as defined in the appending claims. For instance, instead of the filter capacitor 237, a filter capacitor may be connected between second lamp output terminal 263b and the first bridge input terminal 261 and/or a filter capacitor connected between second lamp output terminal 263b and the second bridge input terminal 262.

Further, in the case of embodiment 401 of FIG. 4, it should be clear to a person skilled in the art that breaking the switch 422 may lead to an inductive voltage peak over the input winding 421. To handle such peaks, the input circuit may be provided by a snubber circuit, as is known per se.

Further, although in general the windings ratio of first output winding 321B; 424 and second output winding 321A; 425 will be equal to one, such is not essential, and it may in certain circumstances be useful to have a windings ratio differing from one.

Summarizing, the present invention provides a two-stage electronic ballast for driving a gas discharge lamp. As a first stage, the ballast comprises a half-bridge commutating forward (HBCF) stage comprising a series arrangement of a first buffer capacitor and a second buffer capacitor connected between two bridge input terminals. As a second stage, the ballast comprises a double flyback converter stage comprising an inductive energy storage buffer having at least one input circuit suitable for receiving a rectified AC mains input voltage, the buffer further having at least two output circuits, each output circuit being coupled to a respective buffer capacitor of said half-bridge commutating forward stage [symbol] lly charging said buffer capacitors. Thus, the present invention succeeds in providing a two-stage electronic ballast which is capable of driving a gas discharge lamp with a commutating current having a variable duty cycle, as desired, differing from 50%, this duty cycle being capable of being set variably by a user such as to provide a lamp current with DC component, of which the level can be set by setting the duty cycle. This may be particularly useful in the case of a gas discharge lamp, particularly a metal halide lamp, of a type which has light generating properties depending on the DC current level in the lamp current.

1. Two-stage electronic ballast for driving a gas discharge lamp, specifically a HID lamp, more specifically a metal halide lamp; the ballast comprising:
a half-bridge commutating forward stage comprising a series arrangement of a first buffer capacitor and a second buffer capacitor connected between two bridge input terminals; and
a double flyback converter stage comprising an inductive energy storage buffer having at least one input circuit suitable for receiving a rectified AC mains input voltage, the buffer further having at least two output circuits, each output circuit being coupled to a respective buffer capacitor of said half-bridge commutating forward stage for individually charging said buffer capacitors.

2. Two-stage electronic ballast according to claim 1, wherein said half-bridge commutating forward stage further comprises:
a series arrangement of a first controllable switch and a second controllable switch connected between said two bridge input terminals;
a series arrangement of a lamp output and a current control inductor connected between on the one hand a first node between said two buffer capacitors, and on the other hand a second node between said two controllable switches;
a lamp current control unit operatively coupled to said two controllable switches, the lamp current control unit being adapted to control the operative state of each controllable switch such that, in a first half period, the first switch is maintained in an open condition (non-conductive) while the second switch is switched open and closed at a relatively high frequency, whereas in a second half period, the second switch is maintained in an open condition (non-conductive) while the first switch is switched open and closed at a relatively high frequency.

3. Two-stage electronic ballast according to claim 1, wherein the input circuit of the inductive energy storage buffer comprises a first winding and a third controllable switch connected in series with the first winding;
wherein the first output circuit of the inductive energy storage buffer comprises a second winding connected in series to said first winding, the second winding having a free end and a second end connected to said first winding, the first output circuit further comprising a first diode coupled between said free end of the second winding and the first bridge input terminal, and a common conductor coupled between said second end of the second winding and said first node between said two buffer capacitors; and
wherein the second output circuit of the inductive energy storage buffer comprises said first winding, said first winding having a free end and a second end connected to said second winding, the second output circuit further comprising said common conductor and a second diode coupled between said free end of the first winding and the second bridge input terminal.

4. Two-stage electronic ballast according to claim 1, wherein the input circuit of the inductive energy storage buffer comprises a first winding and a third controllable switch connected in series with said first winding;
wherein the first output circuit of the inductive energy storage buffer comprises a second winding inductively coupled to said first winding, the second winding having a first end coupled to the first bridge input terminal and a second end coupled to said node between said two buffer capacitors, the first output circuit further comprising a first diode coupled in series to said second winding; and
wherein the second output circuit of the inductive energy storage buffer comprises a third winding inductively coupled to said first winding, the third winding having a first end coupled to the second bridge input terminal and a second end coupled to said node between said two buffer capacitors, the second output circuit further comprising a second diode coupled in series to said third winding.

5. Two-stage electronic ballast according to claim 4, wherein said first diode is connected between said second winding first end and said first bridge input terminal.

6. Two-stage electronic ballast according to claim 4, wherein said first diode is connected between said second winding second end and said node.

7. Two-stage electronic ballast according to claim 4, wherein said second diode is connected between said third winding first end and said second bridge input terminal.

8. Two-stage electronic ballast according to claim 4, wherein said second diode is connected between said third winding second end and said node.

9. Two-stage electronic ballast according to claim 1, wherein the inductive energy storage buffer further comprises an output voltage control unit operatively coupled to said third controllable switch, the output voltage control unit being adapted to control the operative state of said third controllable switch such that the output voltage of the flyback converter stage, as measured between the two bridge input terminals, remains substantially at a predetermined constant value.

10. Two-stage electronic ballast according to claim 8, wherein the output voltage control unit comprises a voltage sensor input coupled to receive a measuring signal representing the output voltage of the flyback converter stage, and wherein the output voltage control unit is adapted to generate a switch actuating signal such that the third controllable switch is switched open and closed at a predetermined operating frequency, the output voltage control unit being responsive to said measuring signal to adapt the duty cycle of said switch actuating signal in order to maintain the output voltage at a predetermined level.

11. Two-stage electronic ballast according to claim 10, wherein said measuring signal represents the voltage over said series arrangement of first buffer capacitor and second buffer capacitor.

12. Two-stage electronic ballast according to claim 2, wherein said lamp current control unit is responsive to a command signal to set a duty cycle of said first and second controllable switches at a value which may differ from 50%, such that a lamp current may have a DC component.

13. Light generating assembly comprising a gas discharge lamp, particularly a metal halide lamp, and a two-stage electronic ballast according to claim 1.

14. Light generating assembly according to claim 13, wherein said lamp is of a type which has varying light generating properties depending on the DC current level.
